(19) United States
(12) Patent Application Publication
(10) Pub. No.: US 2024/0312432 A1
(43) Pub. Date: Sep. 19, 2024

(54) METHOD FOR EDITING CONTENT BEING PLAYED IN DISPLAY DEVICE, AND ELECTRONIC DEVICE THEREFOR

(71) Applicant: Samsung Electronics Co., Ltd., Suwon-si (KR)

(72) Inventors: Heejeong KIM, Suwon-si (KR); Heejun KANG, Suwon-si (KR); Kwanmi KIM, Suwon-si (KR)

(73) Assignee: Samsung Electronics Co., Ltd., Suwon-si (KR)

(21) Appl. No.: 18/678,533

(22) Filed: May 30, 2024

Related U.S. Application Data
(63) Continuation of application No. PCT/KR2022/018971, filed on Nov. 28, 2022.

(30) Foreign Application Priority Data
Dec. 2, 2021 (KR) 10-2021-0171198

(51) Int. Cl. G09G 5/00; G06F 3/14; G06T 3/40

(52) U.S. Cl. CPC G09G 5/005; G06F 3/1446; G06T 3/40; G09G 2340/045

(57) ABSTRACT

A method of editing content being played on a display device is disclosed. In detail, the disclosed method includes: receiving, from the display device, a captured content image and information with respect to the content; transmitting the captured content image to a device of a user and receiving editing information with respect to the content from the device; editing the content stored in a memory, based on at least one of the received editing information and the information with respect to the content; and controlling a communicator to transmit the edited content to the display device so that the edited content is played on the display device.

### CROSS-REFERENCE TO RELATED APPLICATIONS

This application is a continuation of International Application No. PCT/KR2022/018971 designating the United States, filed on Nov. 28, 2022, in the Korean Intellectual Property Receiving Office and claiming priority to Korean Patent Application No. 10-2021-0171198, filed on Dec. 2, 2021, in the Korean Intellectual Property Office, the disclosures of each of which are incorporated by reference herein in their entireties.

### BACKGROUND

### Field

One or more embodiments of the present disclosure relate to a method and an electronic device for editing content being played on a display device.

### Description of Related Art

When a display device displays content, it may be necessary to edit the content according to a playing situation of the content. For example, depending on a dimension of the display device and resolution of the content, some areas of the content may not be properly played on the display device.

However, display devices may operate in a way to play content in a predesignated size. Thus, when editing of content is necessary, the content has to be entirely corrected each time for each display device, which causes inconvenience.

### SUMMARY

According to an embodiment of the present disclosure, there are provided a method and an electronic device for editing content being played on a display device, which allow adaptive editing of the content being played on the display device.

An electronic device according to an aspect of the present disclosure includes: a communicator; a memory storing one or more instructions; and at least one processor configured to execute the one or more instructions to control a captured content image of content being played on a display device and information with respect to the content to be received from the display device through the communicator, control the communicator to transmit the captured content image to a device of a user and to receive editing information with respect to the content from the device, edit the content stored in the memory, based on at least one of the received editing information and the information with respect to the content, and control the communicator to transmit the edited content to the display device so that the edited content is played on the display device.

In the electronic device according to an embodiment of the present disclosure, the at least one processor may further be configured to edit the content based on at least one of the received editing information and the information with respect to the content, via an artificial intelligence (AI) model for editing the content.

In the electronic device according to an embodiment of the present disclosure, the AI model may be configured to improve image quality of the content, and the editing information may include at least one of information with respect to selection of a play area of the content, information with respect to enlargement of the play area of the content, information with respect to reduction of the play area of the content, and information with respect to addition of an image or addition of text to the content.

In the electronic device according to an embodiment of the present disclosure, when the received editing information is the information with respect to the enlargement of the play area of the content, the at least one processor may further be configured to improve the image quality of the content by performing upscaling on the content, via the AI model.

In the electronic device according to an embodiment of the present disclosure, when the received editing information is the information with respect to the reduction of the play area of the content, the at least one processor may further be configured to improve the image quality of the content by performing at least one of denoising, brightness adjusting, and texture adjusting on the content, via the AI model.

In the electronic device according to an embodiment of the present disclosure, the information with respect to the content may include at least one of information with respect to image quality of the content and dimension information of the display device playing the content.

In the electronic device according to an embodiment of the present disclosure, the dimension information of the display device may include at least one of horizontal dimension information of the display device and vertical dimension information of the display device, and the at least one processor may further be configured to edit the content, based on at least one of the received editing information and the dimension information of the display device.

In the electronic device according to an embodiment of the present disclosure, the at least one processor may further be configured to control the communicator to transmit, to the device, at least one of a signal with respect to whether or not to edit the content and a signal with respect to an editing direction of the content and the captured content image.

In the electronic device according to an embodiment of the present disclosure, the at least one processor may further be configured to edit the content based on at least one of information with respect to arrangement of a plurality of display devices, the received editing information, and the information with respect to the content, so that the plurality of display devices integrally play the content.

In the electronic device according to an embodiment of the present disclosure, the at least one processor may further be configured to control the communicator to receive, from the display device, the information with respect to the content, according to an editing request signal of the user with respect to the content, transmitted from the device.

A method according to an aspect of the present disclosure includes: receiving, from a display device, a captured content image of content being played on the display device and information with respect to the content; transmitting the captured content image to a device of a user and receiving editing information with respect to the content from the device; editing the content, based on at least one of the received editing information and the information with respect to the content; and transmitting the edited content to the display device so that the edited content is played on the display device.

A non-transitory recording medium according to an aspect of the present disclosure includes a computer-readable recording medium having recorded thereon a program for executing the method, on a computer.

### BRIEF DESCRIPTION OF THE DRAWINGS

FIG. 1 is a diagram for describing a system for editing content being played on a display device, according to an embodiment of the present disclosure.

FIG. 2 is a block diagram of an electronic device configured to edit content being played on a display device, according to an embodiment of the present disclosure.

FIG. 3 is a flowchart for editing content being played on a display device, according to an embodiment of the present disclosure.

FIG. 4 is a flowchart of a method of transmitting a captured content image to a device of a user and receiving editing information with respect to content from the device, according to an embodiment of the present disclosure.

FIG. 5 is a diagram for describing editing information with respect to content according to an embodiment of the present disclosure.

FIG. 6 is a diagram for describing editing information with respect to content according to an embodiment of the present disclosure.

FIG. 7 is a flowchart of a method of editing content based on at least one of received editing information and information with respect to the content and improving image quality of the content, via an artificial intelligence (AI) model, according to an embodiment of the present disclosure.

FIG. 8 is a diagram for describing a method of editing content, via an AI model, based on at least one of received editing information and information with respect to the content, when the received editing information is information with respect to enlargement of a play area of the content, according to an embodiment of the present disclosure.

FIG. 9 is a diagram for describing a method of editing content, via an AI model, based on at least one of received editing information and information with respect to the content, when the received editing information is information with respect to reduction of a play area of the content, according to an embodiment of the present disclosure.

FIG. 10 is a diagram for describing a method of editing content based on at least one of received editing information and dimension information of a display device, according to an embodiment of the present disclosure.

FIG. 11 is a diagram for describing a method of editing content based on at least one of information with respect to arrangement of a plurality of display devices, received editing information, and information with respect to the content, for the plurality of display devices to integrally play the content, according to an embodiment of the present disclosure.

FIG. 12 is a diagram for describing a method of editing content based on at least one of information with respect to arrangement of a plurality of display devices, received editing information, and information with respect to the content, for the plurality of display devices to integrally play the content, according to an embodiment of the present disclosure.

FIG. 13 is a diagram for describing a method of editing content based on at least one of information with respect to arrangement of a plurality of display devices, received editing information, and information with respect to the content, for the plurality of display devices to integrally play the content, according to an embodiment of the present disclosure.

FIG. 14 is a diagram for describing a method of editing content based on at least one of information with respect to arrangement of a plurality of display devices, received editing information, and information with respect to the content, for the plurality of display devices to integrally play the content, according to an embodiment of the present disclosure.

### DETAILED DESCRIPTION

The terms used in the present disclosure will be briefly described, and then an embodiment of the present disclosure will be described in detail.

The terms used in the present disclosure are general terms as possible that have been widely used nowadays in consideration of the functions in the present disclosure, which, however, may be changed according to an intention of a technician in the art, a precedent, the advent of new technologies, or the like. Also, particular cases may include terms arbitrary selected by an applicant, and in this case, the meaning of the terms will be described in detail in the corresponding description. Therefore, the terms used in the present disclosure should be defined based on the meanings of the terms and the content throughout the present disclosure, rather than simply based on the titles of the terms.

Throughout the specification, when a part “includes” or “comprises” an element, the part may further include other elements, rather than excluding the other elements, unless there is a particular description contrary thereto. Also, the term “unit” used in the specification denotes software or hardware components such as a field-programmable gate array (FPGA) or an application specific integrated circuit (ASIC) and the “unit” performs certain functions. However, the meaning of the term “unit” is not limited to the software or the hardware. A “unit” may be configured to be in a storage medium which may be addressed or may be configured to play one or more processors. Thus, for example, a “unit” may include components, such as software components, object-oriented software components, class components, and task components, processes, functions, attributes, procedures, sub-routines, segments of a program code, drivers, firmware, a microcode, a circuit, data, a database, data structures, tables, arrays, and variables. The components and functions provided by the “units” may be combined into a reduced number of components or “units” or may further be divided into additional components and “units.”

Hereinafter, an embodiment of the present disclosure will be described in detail with reference to the accompanying drawings, so that the embodiment of the present disclosure may be easily implemented by one of ordinary skill in the art. However, an embodiment of the present disclosure may have different forms and should not be construed as being limited to the embodiment of the present disclosure described herein. Also, in the drawings, parts not related to descriptions are omitted for the clear description of an embodiment of the present disclosure, and throughout the specification, like reference numerals are used for like elements.

Throughout the specification, when a part is referred to as being “connected” to other parts, the part may be “directly connected” to the other parts or may be “electrically connected” to the other parts with other devices therebetween. Also, when a part “includes” a certain element, unless it is specifically mentioned otherwise, the part may further include another component and may not exclude the other component.

Terminology such as “at least one of A and B”, as may be used herein, includes any of the following: A, B, A and B. Terminology such as “at least one of A, B, and C”, as may be used herein, includes any of the following: A, B, C, A and B, A and C, B and C, A and B and C.

Similarly, terminology such as “at least one of A or B”, as may be used herein, includes any of the following: A, B, A and B. Terminology such as “at least one of A, B, or C”, as may be used herein, includes any of the following: A, B, C, A and B, A and C, B and C, A and B and C.

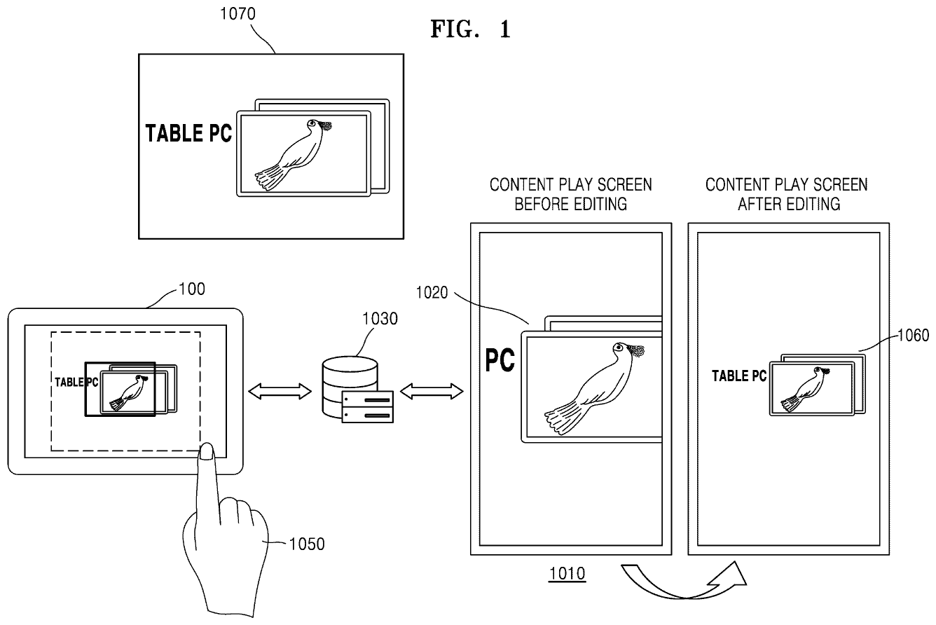

FIG. 1 is a diagram for describing a system for editing content being played on a display device, according to an embodiment of the present disclosure.

Referring to FIG. 1, in the system, a device 100, a server 1030 configured to edit content being played on a display device, and a display device 1010 playing content are illustrated.

The display device 1010 according to an embodiment of the present disclosure may be configured to obtain original content 1070 from the server 1030 and play the obtained original content 1070. For example, the display device 1010 may be configured to intactly play the obtained original content 1070. When image quality information of the original content 1070 obtained by the display device 1010 from the server 1030 and dimension information of the display device 1010 do not correspond to each other, the display device 1010 may play only some areas of the original content 1070.

A content play screen before editing 1020 according to an embodiment of the present disclosure may be a play screen corresponding to original content played through the display device 1010. In detail, the content play screen before editing 1020 may indicate a play screen corresponding to original content played on a display of the display device 1010. For example, while the original content 1070 may include the text “Tablet PC,” the display device 1010 may play only some areas of the original content 1070, so that the content play screen before editing 1020 displayed on the display of the display device 1010 may include only “PC,” not including “Tablet.”

The display device 1010 according to an embodiment of the present disclosure may capture a content image displayed on the display while playing content and may transmit the captured content image and information with respect to the content to the server 1030. For example, for a user to monitor content, the display device 1010 may periodically transmit, to the server 1030, the captured content image and the information with respect to the content. The information with respect to the content transmitted to the server 1030 may include at least one of information about image quality of the content and dimension information of the display device playing the content.

The display device 1010 according to an embodiment of the present disclosure may transmit only the captured content image to the server 1030 or may transmit, together with the captured content image, information indicating to which part of original content the captured content image corresponds, to the server 1030. In order to perform editing based on a content image captured by the server 1030 or the device 100, it is required to figure out to which part of the original content 1070 the corresponding captured content image corresponds to perform the editing. Thus, together with the captured content image, the display device 1010 may transmit, to the server 1030, the information indicating to which part of the original content 1070 the captured content image corresponds. The information indicating to which part of the original content 1070 the captured content image corresponds may include, for example, at least one of information about a play time of the captured content image and an original content image corresponding to the captured content image. However, the display device 1010 may not necessarily have to transmit such information. According to other embodiments, the server 1030 or the device 100 may obtain, based on a captured content image, an original content image corresponding to the captured content image.

The captured content image according to an embodiment of the present disclosure may indicate the content play screen before editing 1020 that is displayed on the display device 1010. Also, in this specification, the captured content image may indicate an image in which the content play screen before editing 1020 is displayed on the original content image 1070. In detail, the sever 1030 may receive, from the display device 1010, the information about the play time of the captured content image and the server 1030 may obtain, based on the information about the play time of the captured content image and the original content image 1070, the original content image corresponding to the content play screen before editing 1020. The server 1030 may display the content play screen before editing 1020 on the obtained original content image 1070. For example, referring to FIG. 1, the captured content image may indicate an image in which the content play screen before editing 1020 is indicated on the original content image 1070 by using black edges.

The server 1030 according to an embodiment of the present disclosure may obtain the captured content image or the information with respect to the content from the display device 1010.

The server 1030 may receive time information of currently played content from the display device 1010 and the server 1030 may obtain, based on the time information of the content and the original content 1070, the original content image corresponding to the captured content image. The server 1030 may obtain the original content image corresponding to the captured content image by recognizing the image using an image recognition technique, etc. on the captured content image received from the display device 1010.

The server 1030 may transmit the captured content image to the device 100 and may receive editing information with respect to the content from the device 100. Here, along with the captured content image, the server 1030 may transmit, to the device 100, the information with respect to the content and information indicating the original content image corresponding to the captured content image. The device 100 may indicate a device 100 manipulated by a user, and here, the user may indicate an entity manufacturing, editing, or processing the content. The content editing used in the present disclosure may include operations of editing, processing, forming content, etc. based on image quality information of the content or specification information or dimension information of the display device playing the content. For example, the user may input an editing feature with respect to the content through the device 100, and the editing information with respect to the content including the editing feature may be transmitted to the server 1030. The server 1030 may edit the original content 1070 based on the transmitted editing information.

The editing information with respect to the content according to an embodiment of the present disclosure may include at least one of information with respect to selection of a play area of the content, information with respect to enlargement of the play area of the content, information with respect to reduction of the play area of the content, and information with respect to addition of an image or text to the content. For example, the information with respect to enlargement of the play area of the content may indicate editing information for zooming-in the play area of the content and the information with respect to reduction of the play area of the content may indicate editing information for zooming-out the play area of the content.

The user according to an embodiment of the present disclosure may monitor the captured content image obtained from the server 1030 and may determine whether or not to edit the original content 1070. Referring to FIG. 1, based on the captured content image monitored by the user, the display device 1010 may play only some areas of the original content 1070, and thus, the user may determine to perform the editing of reducing the play area of the original content 1070. Accordingly, the device 100 of the user may transmit, to the server 1030, the editing information including an editing feature 1050 of reducing the play area of the original content 1070.

The server 1030 according to an embodiment of the present disclosure may receive the editing information from the device 100. The server 1030 may edit the original content 1070 based on at least one of the editing information received from the device 100 and the information with respect to the content obtained from the display device 1010. In detail, through an artificial intelligence (AI) model, the server 1030 may edit the original content 1070 stored in a memory of the server 1030, based on at least one of the received editing information and the information with respect to the content. Also, the server 1030 may transmit the edited content through a communicator so that the display device may play the edited content. For example, referring to FIG. 1, the server 1030 may perform the editing of zooming-out the original content 1070, based on the editing information including the editing feature 1050 of reducing the play area. The server 1030 may redistribute the edited content to the display device 1010, thereby rapidly and conveniently providing the content edited according to a display situation of the display device 1010 without intervention of a user of the display device 1010.

The display device 1010 according to an embodiment of the present disclosure may receive the edited content and display the edited content. For example, a play screen 1060 of the edited content may be a play screen on which “Tablet PC” also including “Tablet,” which was not output on the content play screen before editing 1020, is entirely output.

According to an embodiment of the present disclosure, the user may transmit the editing information of the original content 1070 determined based on the content image captured by the device 1010 to the server 1030 through the device 100. After the server 1030 edits the original content 1070 based on at least one of the editing information and the information with respect to the content, the server 1030 may redistribute the edited content to the display device 1010. Thus, the display device 1010 may directly output the edited content.

The display device 1010 according to an embodiment of the present disclosure may indicate a device including a display, such as a television (TV), a smartphone, etc. Also, the device 100 may include a user input unit, such as a pad touch, etc. in order to recognize the editing information of the user, but is not limited thereto.

In the example illustrated in FIG. 1, the server 1030 and the device 100 are separate devices from each other. However, embodiments are not limited thereto. As another example, the server 1030 and the device 100 may be integrated into one device.

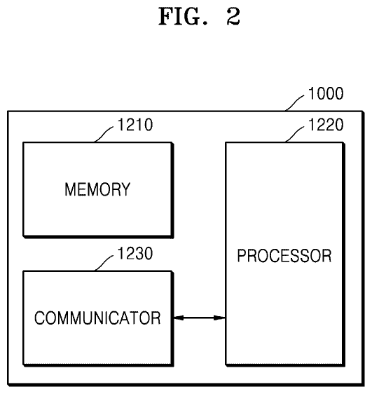

FIG. 2 is a block diagram of an electronic device configured to edit content being played on a display device, according to an embodiment of the present disclosure.

Referring to FIGS. 1 and 2, an electronic device 1000 according to an embodiment of the present disclosure may be an electronic device for editing content that is being played on the display device. In detail, the electronic device 1000 may be a device configured to edit content based on editing information with respect to the content obtained from the device 100 of the user and information with respect to the content obtained from the display device 1010. For example, the electronic device may include various types of devices which may be used by a user, such as a cellular phone, a tablet personal computer (PC), a personal digital assistant (PDA), an MP3 player, a kiosk, an electronic frame, a navigation device, a digital TV, or a wearable device such as a wrist watch or a head-mounted display (HMD). Also, the electronic device 1000 according to an embodiment of the present disclosure may be a server but is not limited thereto.

The electronic device 1000 according to an embodiment of the present disclosure may include a memory 1210, a processor 1220, and a communicator 1230. Hereinafter, the components above are sequentially described.

The memory 1210 may store a program for processing and controlling operations by the processor 1220. The memory 1210 according to an embodiment of the present disclosure may store one or more instructions. The memory 1210 may include at least one of an internal memory (not shown) and an external memory (not shown).

The memory 1210 may store various programs and data used for operations of the electronic device 1000. For example, the memory 1210 may store an AI model for editing content. The AI model may be configured to edit content or improve image quality of the content but is not limited thereto. The AI model may include a content editing model trained by using image data before editing and image data after editing as training data. The AI model may be configured to improve image quality of content by performing at least one of denoising, brightness adjusting, texture adjusting, and upscaling on the content. The memory 1210 may store original content played on the display device 1010.

The internal memory include, for example, at least one of a volatile memory (for example, dynamic random-access memory (RAM) (DRAM), static RAM (SRAM), synchronous DRAM (SDRAM), etc.), a nonvolatile memory (for example, one-time programmable read-only memory (ROM) (OTPROM), programmable ROM (PROM), erasable and programmable ROM (EPROM), electrically erasable and programmable ROM (EEPROM), mask ROM, flash ROM, etc.), a hard disk drive (HDD), and a solid state drive (SSD). According to an embodiment, the processor 1220 may load a command or data received from at least one of the nonvolatile memory and other components on the volatile memory and process the command or the data. Also, the processor 1220 may store data received or generated from other components in the nonvolatile memory.

The external memory may include, for example, at least one of compact flash (CF), secure digital (SD), micro-SD, mini-SD, extreme digital (xD), and a memory stick.

The processor 1220 may control general operations of the electronic device 1000 and may execute the one or more instructions stored in the memory 1210 to control the operations of the electronic device 1000. The processor 1220 may execute the programs stored in the memory 1210 to generally control the communicator 1230, a power supply unit (not shown), etc.

The processor 1220 may include at least one of RAM, ROM, a central processing unit (CPU), a graphics processing unit (GPU), and a bus. The RAM, the ROM, the CPU, the GPU, etc. may be connected with one another through the bus. According to an embodiment of the present disclosure, the processor 1220 may include an AI processor configured to generate a training network model but is not limited thereto. According to an embodiment of the present disclosure, the AI processor and the processor 1220 may be realized as different chips from each other. According to an embodiment of the present disclosure, the AI processor may be a general-purpose chip.

The processor 1220 according to an embodiment of the present disclosure may control a content image captured on the display device 1010 and information with respect to content to be received through the communicator 1230, may control the captured content image to be transmitted to the device 100 through the communicator 1230, may control the communicator 1230 to receive editing information with respect to the content from the device 100, may edit the content based on at least one of the received editing information and the received information with respect to the content, and may control the communicator 1230 to transmit the edited content to the display 1010 so that the edited content is played on the display device 1010.

The communicator 1230 may include one or more components configured to enable communication between the electronic device 1000 and a plurality of devices around the electronic device 1000. The plurality of devices may include the display device 1010 configured to display content and the device 100 of the user. The communicator 1230 may include one or more components configured to enable communication between the electronic device 1000 and a server or a cloud. In detail, the communicator 1230 may perform communication with various types of external devices or servers according to various types of communication methods. Also, the communicator 1230 may include a short-range wireless communication unit (not shown).

The short-range wireless communicating unit (not shown) may include a Bluetooth communicator, a BLE communicator, a near-field communicator, a WLAN (Wi-Fi) communicator, a Zigbee communicator, an infrared data association (IrDA) communicator, a Wi-fi direct (WFD) communicator, a UWB communicator, an Ant+ communicator, an Ethernet communicator, etc. but is not limited thereto.

The electronic device 1000 according to an embodiment of the present disclosure may receive a content image captured on the display device 1010 and information with respect to content, through the communicator 1230. Also, through the communicator 1230, the electronic device 1000 may receive, together with the captured content image, information indicating to which part of original content the captured content image corresponds. Through the communicator 1230, the electronic device 1000 may transmit the captured content image to the device 100 of the user and may receive editing information with respect to the content from the device 100 of the user. Also, the electronic device 1000 may transmit edited content through the communicator for the display device 1010 to play the edited content.

The electronic device 1000 may further include a power supply unit (not shown). The power supply unit (not shown) may supply power to the components of the electronic device 1000 according to control by the processor 1220. The power supply unit (not shown) may supply the power that is input from an external power source to each of the components of the electronic device 100 through a power code according to control by the processor 1220.

However, not all of the illustrated components are essential components. The electronic device 1000 may be realized by including a greater or less number of components than the illustrated components.

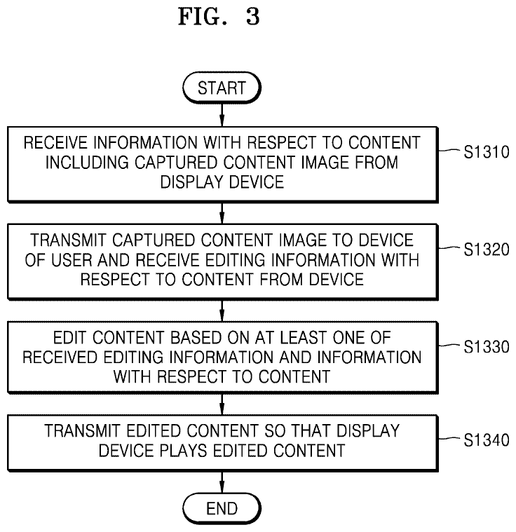

FIG. 3 is a flowchart for editing content being played on a display device according to an embodiment of the present disclosure.

Referring to FIGS. 1, 2, and 3, in operation S1310, the electronic device 1000 according to an embodiment of the present disclosure may receive a content image captured on the display device 1010 and information with respect to content.

The electronic device 1000 according to an embodiment of the present disclosure may receive the content image captured on the display device 1010 and the information with respect to content, through the communicator 1230. For example, the display device 1010 may periodically transmit the captured content image and the information with respect to the content and the electronic device 1000 may receive the captured content image and the information with respect to the content. Also, for example, the electronic device 1000 may receive a content-editing request signal from the device 100 of the user. When the electronic device 1000 receives the editing request signal, the electronic device 1000 may control the communicator 1230 to receive the information with respect to the content from the display device 1010. However, the electronic device 1000 is not limited thereto.

The display device 1010 according to an embodiment of the present disclosure may transmit only the captured content image to the electronic device 1000 or may transmit, together with the captured content image, information indicating to which part of original content the captured content image corresponds, to the electronic device 1000. The information indicating to which part of the original content the captured content image corresponds may include, for example, at least one of information about a play time of the captured content image and an original content image corresponding to the captured content image. However, the display device 1010 may not necessarily have to transmit such information. According to other embodiments, the electronic device 1000 or the device 100 may obtain the original content image based on the captured content image.

The captured content image according to an embodiment of the present disclosure may indicate the content play screen before editing 1020 displayed on the display device 1010. Also, in this specification, the captured content image may indicate an image in which the content play screen before editing is indicated on the original content image. In detail, the electronic device 1000 may receive the information about the play time of the captured content image from the display device 1010 and the electronic device 1000 may obtain, based on the information about the play time of the captured content image and the original content 1070, the original content image corresponding to the content play screen before editing 1020. The electronic device 1000 may display the content play screen before editing 1020 on the obtained original content image 1070. For example, referring to FIG. 1, the captured content image may indicate an image in which the content play screen before editing 1020 is indicated on the original content image 1070 by using black edges.

The electronic device 1000 may receive time information of currently played content from the display device 1010 and the electronic device 1000 may obtain, based on the time information of the content and the original content 1070, the original content image corresponding to the captured content image. The electronic device 1000 may obtain the original content image corresponding to the captured content image by recognizing the image using an image recognition technique, etc. on the captured content image received from the display device 1010.

The information with respect to the content according to an embodiment of the present disclosure may include information about image quality of the content and dimension information of the display device playing the content. For example, the information about the image quality may include information about the resolution of content played on the display device. In detail, the information about the image quality of the content may include information indicating the image quality of the content as at least one of 8K, 4K, 2K, ultra-high-definition (UHD), FULL high-definition (HD), and HD. Also, for example, the information indicating the image quality of the content as 8K may include information that the content includes 8192×4320 pixels.

The dimension information of the display device playing the content according to an embodiment of the present disclosure may include at least one of chromatic aberration dimension information of the display device and resolution dimension information of the display device. For example, the chromatic aberration dimension information of the display device may include information indicating the chromatic aberration dimension of the display device as at least one of a color graphics adapter (CGA), an enhanced graphics adapter (EGA), a video graphics array (VGA), an extended graphics array (XGA), and a super VGA (SVGA). Also, for example, the resolution dimension information of the display device may include information indicating the resolution dimension of the display device as at least one of QQVGA (160×120), QCIF (176×144), CIF (352×288), QVGA (320×240), VGA (640×480), UXGA (1600×1200), and ultra wide XGA (UWXGA) (9120×1200) but is not limited thereto.

In operation S1320, the electronic device 1000 according to an embodiment of the present disclosure may transmit the captured content image to the device 100 of the user and may receive editing information with respect to the content from the device 100.

The electronic device 1000 according to an embodiment of the present disclosure may transmit the captured content image and a signal related to content editing to the device 100 of the user. The electronic device 1000 may receive, from the device 100, the editing information with respect to the content based on the captured content image and the signal related to the content editing. In detail, the signal related to the content editing transmitted from the electronic device 1000 to the device 100 of the user may include a signal with respect to whether or not to edit content and a signal with respect to a method of editing the content but is not limited thereto.

Along with the captured content image, the electronic device 1000 according to an embodiment of the present disclosure may transmit, to the device 100 of the user, the information with respect to the content and the information indicating the original content image corresponding to the captured content image. Here, the user may indicate an entity manufacturing, editing, or processing the content by using the device 100.

The electronic device 1000 according to an embodiment of the present disclosure may periodically transmit the captured content image received from the display device 1010 to the device 100 of the user. When the user determines based on the captured content image that it is necessary to edit the content displayed on the display device 1010, the user may transmit the editing information with respect to the content to the electronic device 1000 through the device 100 of the user. For example, the editing information may include at least one of information with respect to selection of a play area of the content, information with respect to enlargement of the play area of the content, information with respect to reduction of the play area of the content, and information with respect to addition of an image or text to the content.

In operation S1330, the electronic device 1000 according to an embodiment of the present disclosure may edit the original content 1070 based on at least one of the received editing information and the information with respect to the content.

The electronic device 1000 according to an embodiment of the present disclosure may receive the editing information with respect to the content including an editing feature with respect to the content through the device 100 of the user. The electronic device 1000 may edit the original content 1070 based on at least one of the received editing information and the information with respect to the content.

The electronic device 1000 according to an embodiment of the present disclosure may edit the original content 1070 stored in the memory 1210, based on at least one of the received editing information and the information with respect to the content, through an AI model configured to edit content. According to an embodiment, the AI model configured to edit the content may include a model configured to improve image quality of the content. According to an embodiment, the received editing information may include at least one of information with respect to selection of a play area of the content, information with respect to enlargement of the play area of the content, information with respect to reduction of the play area of the content, and information with respect to addition of an image or text to the content. The electronic device 1000 may adaptively improve the image quality of the content through the AI model, according to the content of the editing information.

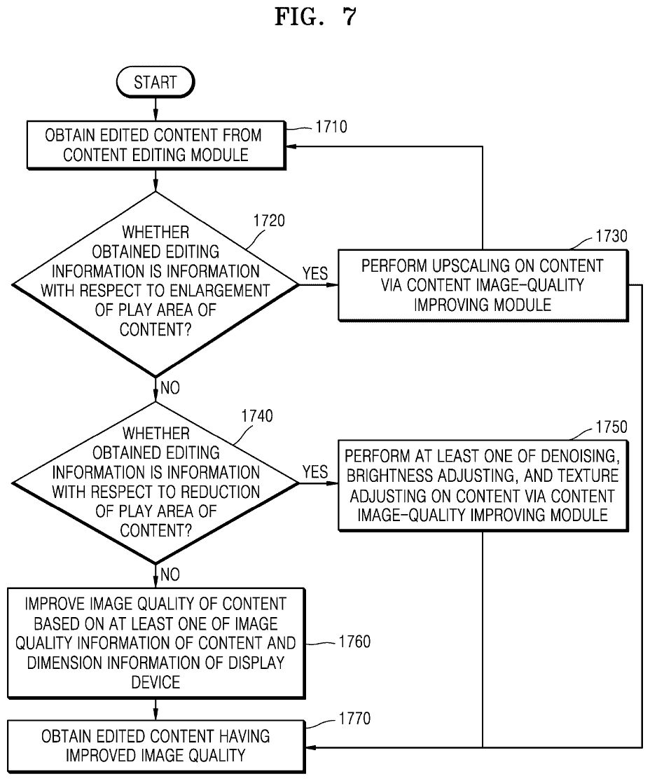

When the received editing information according to an embodiment of the present disclosure is the information with respect to enlargement of the play area of the content, image quality of the content that is edited to enlarge the play area of the original content 1070 may be decreased. Thus, through the AI model, the electronic device may perform upscaling on the content of the original content 1070, the content being subject to editing, so as to improve the image quality of the edited content. Also, when the received editing information is information with respect to reduction of the play area of the content, the content edited to reduce the play area of the original content 1070 may have a faint boundary between objects in the content, etc. Thus, through the AI model, the electronic device may perform at least one of denoising, brightness adjusting, and texture adjusting on the content subject to editing from the original content 1070 to improve the image quality of the edited content. The operation of editing the original content 1070 based on at least one of the received editing information and the information with respect to the content through the AI model configured to edit the content will be described in detail with reference to FIGS. 7 to 9.

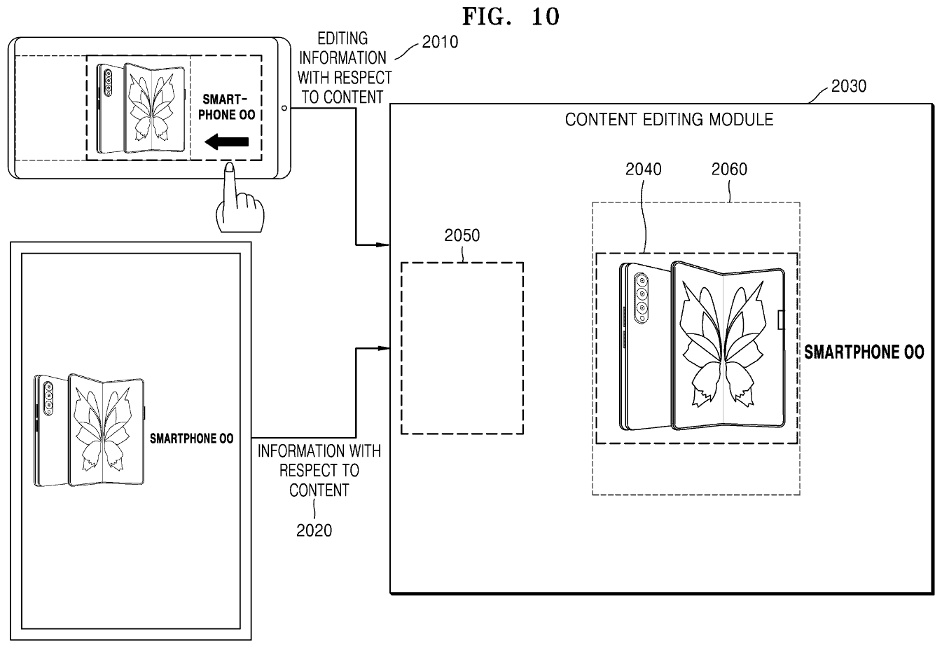

The dimension information of the display device according to an embodiment of the present disclosure may include at least one of horizontal dimension information of the display device and vertical dimension information of the display device. The electronic device 1000 may edit the original content 1070 based on at least one of the received editing information and the dimension information of the display device. For example, a ratio between a horizontal pixel and a vertical pixel of a display of the display device may be different from a ratio between a horizontal pixel and a vertical pixel of the content according to the dimension information of the display device and the information with respect to the content. Thus, the display device 1010 may not be able to properly output some areas of the original content 1070. Here, the electronic device 1000 may appropriately edit the original content 1070 based on at least one of the received editing information and the dimension information of the display device. The operation of editing the original content 1070 based on the at least one of the received editing information and the dimension information of the display device will be described in detail with reference to FIG. 10.

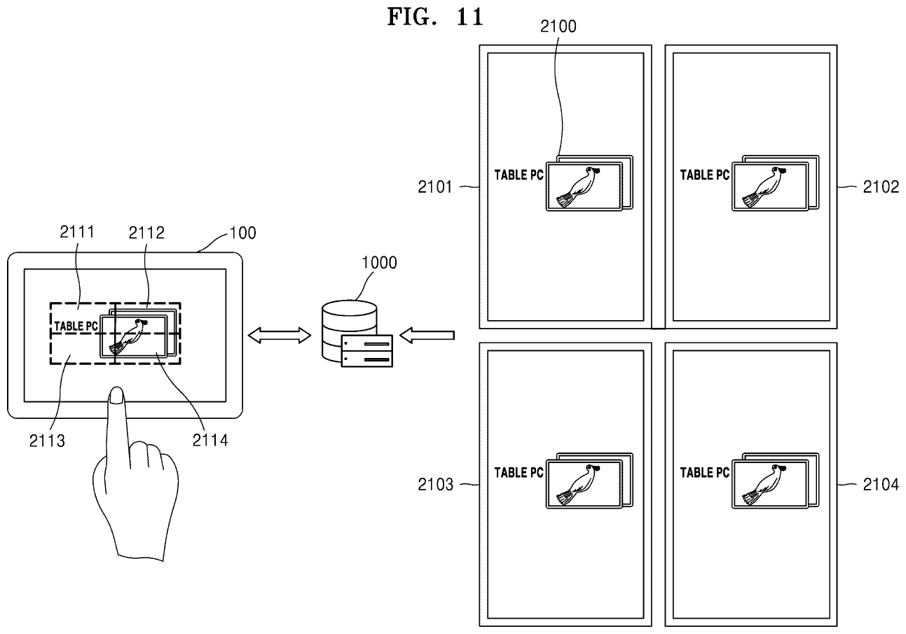

For a plurality of display devices to integrally play the content, according to an embodiment of the present disclosure, the original content 1070 may be edited based on at least one of information with respect to arrangement of the plurality of display devices, the received editing information, and the information with respect to the content. For example, when the plurality of display devices are arranged in upper, lower, left and right directions to operate like one large display, the electronic device may appropriately edit content being played on the plurality of display devices so that the plurality of display devices may integrally play the content. In detail, the electronic device 1000 may edit the original content 1070 such that each of the plurality of display devices may display a segmented part of the content, so that the plurality of display devices may integrally display a single piece of content. The operation of editing the original content 1070 based on the at least one of the information with respect to arrangement of the plurality of display devices, the received editing information, and the information with respect to the content, the operation being performed by the electronic device 1000 for the plurality of display devices to integrally play the content, will be described in detail with reference to FIGS. 11 to 14.

In operation S1340, the electronic device 1000 according to an embodiment of the present disclosure may transmit the edited content so that the display device 1010 may play the edited content.

The electronic device 1000 according to an embodiment of the present disclosure may transmit the edited content to the display device 1010 so that the display device 1010 may play the edited content. As described above, the electronic device 1000 may redistribute the edited content to the display device 1010, and thus, may rapidly and conveniently provide the content edited according to a display situation of the display device 1010 without intervention of the user of the display device 1010.

When the plurality of display devices according to an embodiment of the present disclosure output one piece of content, the electronic device 1000 may transmit, to each of the plurality of display devices, each piece of edited content corresponding to each of the plurality of display devices. Here, each piece of edited content corresponding to each of the plurality of display devices may be different from each other.

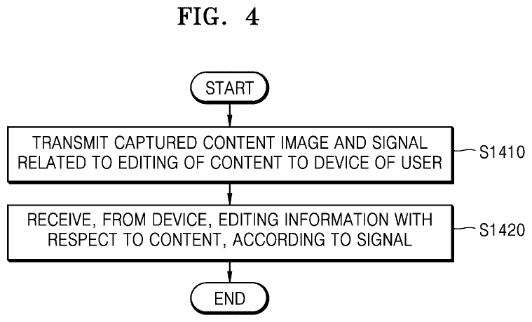

FIG. 4 is a flowchart for describing a method of transmitting a captured content image to a device of a user and receiving editing information with respect to content from the device, according to an embodiment of the present disclosure.

Referring to FIGS. 1, 2, and 4, in operation S1410, the electronic device 1000 according to an embodiment of the present disclosure may transmit the captured content image and a signal related to editing of the content to the device 100 of the user.

The electronic device 1000 according to an embodiment of the present disclosure may transmit the captured content image and the signal related to editing of the content to the device 100 of the user according to a pre-set period. Here, the signal related to editing of the content may include at least one of a signal with respect to whether or not to edit content and a signal with respect to a method of editing the content but is not limited thereto.

The electronic device 1000 according to an embodiment of the present disclosure may receive a content-editing request signal from the device 100 of the user, and in response to the editing request signal, the electronic device 1000 may receive the captured content image and the information with respect to the content from the display device 1010. Also, the electronic device 1000 may transmit the captured content image and the signal related to editing of the content to the device 100 of the user. Here, the signal related to editing of the content may indicate a signal with respect to a method of editing the content but is not limited thereto.

The electronic device 1000 according to an embodiment of the present disclosure may transmit the captured content image to the device 100 of the user and may receive the editing information with respect to the content from the device 100. Here, the electronic device 1000 may transmit, along with the captured content image, the information with respect to the content and the original content image corresponding to the captured content image to the device 100.

In operation S1420, the electronic device 1000 according to an embodiment of the present disclosure may receive the editing information with respect to the content from the device 100, according to a signal.

The electronic device 1000 according to an embodiment of the present disclosure may receive the editing information with respect to the content from the device 100 of the user. For example, the user may transmit the editing information with respect to the content to the electronic device 1000 through the device 100 and the electronic device 1000 may control the communicator 1230 to receive the editing information from the device 100 of the user.

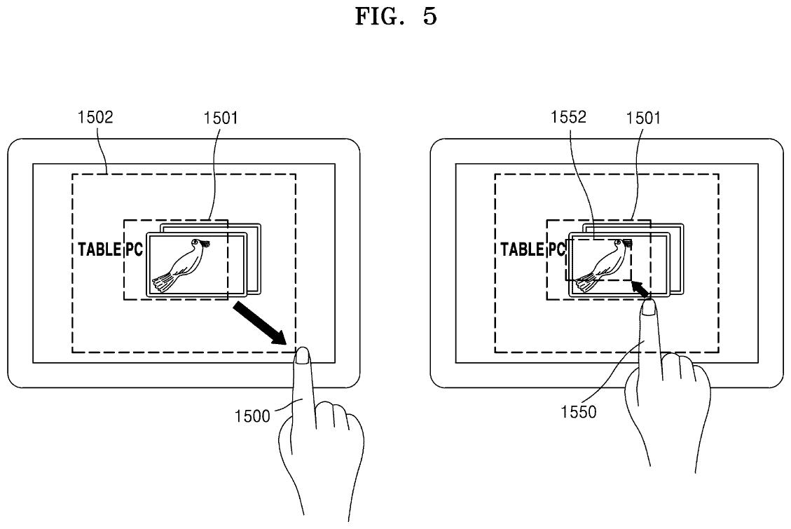

FIG. 5 is a diagram for describing editing information with respect to content according to an embodiment of the present disclosure.

Referring to FIGS. 1 and 5, the editing information according to an embodiment of the present disclosure may be information including an editing feature 1500 of reducing a play area of the content and the information including the editing feature 1500 of reducing the play area of the content may indicate information with respect to zooming-out of the play area of the content. The device 100 of the user may receive a captured content image 1501 from the electronic device 1000. The captured content image 1501 may be an image including only “PC” of “Tablet PC” that is the text in the content. The user may perform a drag & drop operation on the captured content image to input content editing information including the editing feature 1500 of reducing the play area of the captured content image. The device 100 of the user may transmit the editing information for changing the play area of the content in the captured content image 1501 to a play area 1502 of the content after editing to the electronic device 1000. For example, the play area 1502 of the content after editing may indicate a play area including the entire text “Tablet PC.”

The editing information according to an embodiment of the present disclosure may include information including an editing feature 1550 of enlarging the play area of the content and the information including the editing feature 1550 of enlarging the play area of the content may indicate information with respect to zooming-in of the play area of the content. The device 100 of the user may receive the captured content image 1501 from the electronic device 1000. The user may perform a drag & drop operation on the captured content image to input content editing information including the editing feature 1550 of enlarging the play area of the captured content image. The device 100 of the user may transmit the editing information for changing the play area of the content in the captured content image 1501 to a play area 1552 of the content after editing to the electronic device 1000. For example, the content may be related to an advertisement of a tablet PC and the play area 1552 of the content after editing may indicate a zoomed-in play area of the original content 1070. For example, referring to FIG. 5, the play area 1552 of the content after editing may include a bird in the tablet PC to emphasize the image quality of the tablet PC in the original content 1070 but is not limited thereto.

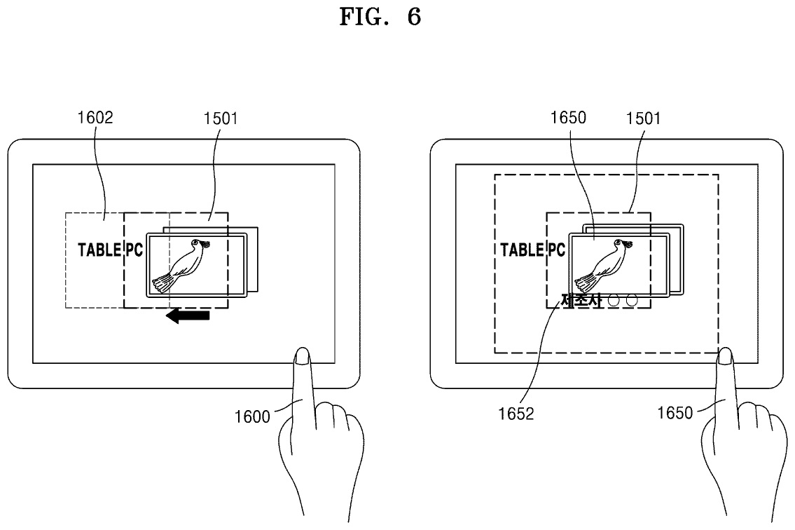

FIG. 6 is a diagram for describing editing information with respect to content according to an embodiment of the present disclosure.

Referring to FIGS. 1 and 6, the editing information according to an embodiment of the present disclosure may be information including an editing feature 1600 of selecting a play area of the content. For example, when the number of pixels of the play area of the content 1020 before editing is the same as the number of pixels in the play area of the content after editing, but a position of the play area of the content 1020 before editing is different from a position of the play area of the content after editing, the information including the editing feature 1600 of selecting the play area of the content may indicate information with respect to a shift of the play area of the content. A user may perform a drag & drop operation on the captured content image to input content editing information including the editing feature 1600 of selecting the play area of the content. The device 100 of the user may transmit the editing information for changing the play area of the content in the captured content image 1501 to a play area 1602 of the content after editing to the electronic device 1000. For example, the captured content image 1501 may display only “PC” of “Tablet PC” which is the text in the content and the play area 1602 of the content after editing may indicate a play area of the content that is edited to include “Tablet PC,” which is the entire text in the image.

The editing information according to an embodiment of the present disclosure may be information including an editing feature 1650 of adding an image or text to the content. According to an embodiment, a user may input the editing information with respect to the content including the editing feature 1650 of adding the text to the content, by performing an operation of adding a piece of text 1652 “manufacturer [symbol] ” to the captured content image 1501 through simple setting. However, the present disclosure is not limited thereto and the user may perform an operation of adding an image to the captured content image 1501. The device 100 of the user may transmit the editing information with respect to the content including the feature of adding the text 1652 or the image to the content to the electronic device 1000. Based on the received editing information, the electronic device 1000 may perform the editing of adding the text 1652, which is “manufacturer [symbol] ” to the original content.

, is a flowchart of a method of editing content based on at least one of received editing information and information with respect to the content and improving image quality of the content, via an AI model, according to an embodiment of the present disclosure.

Referring to FIGS. 1, 2, and 7, the electronic device 1000 according to an embodiment of the present disclosure may edit content based on at least one of received editing information and information with respect to the content, via an AI model stored in the memory 1210, and may improve the image quality of the content. For example, the AI model may include a content editing module and a content image-quality improving module, and the processor 1220 of the electronic device 1000 may edit the content through the content editing module. Also, for example, the processor 1220 of the electronic device 1000 may improve the image quality of the content through the content image-quality improving module.

The electronic device 1000 according to an embodiment of the present disclosure may edit original content based on at least one of the editing information and the information with respect to the content, through the content editing module. For example, based on the editing information of FIGS. 5 and 6, the electronic device 1000 may perform an editing operation 1500, 1550, or 1600 of selecting, reducing, or enlarging a play area of the content or may perform an editing operation 1650 of adding text or an image to the content but is not limited thereto. In detail, the electronic device 1000 may edit the content based on at least one of dimension information of the display device and image quality information of the content.

In operation S1710, the electronic device 1000 according to an embodiment of the present disclosure may obtain the edited content from the content editing module.

The content image-quality improving module according to an embodiment of the present disclosure may obtain the edited content from the content editing module. The operation by the content image-quality improving module and the operation by the content editing module may be performed in parallel with each other, or the operation by the content image-quality improving module may be performed first, and then, the operation by the content editing module may be performed. However, the present disclosure is not limited thereto. Hereinafter, an operation of improving the image quality of the content via the content image-quality improving module, after the content image-quality improving module obtains the edited content from the content editing module, is described.

In operation S1720, the electronic device 1000 according to an embodiment of the present disclosure may determine whether the obtained editing information is information with respect to enlargement of a play area of the content.

When the editing information according to an embodiment of the present disclosure is the information with respect to enlargement of the play area of the content, the editing information may indicate information with respect to zooming-in of the play area of the content. Here, as the content editing module performs the editing of enlarging the play area of the content, the image quality or the resolution of the content may be relatively decreased. Thus, when the obtained editing information is the information with respect to enlargement of the play area of the content, the electronic device 1000 may need to improve image quality of the edited content.

In operation S1730, the electronic device 1000 according to an embodiment of the present disclosure may perform upscaling on the content through the content image-quality improving module.

The electronic device 1000 according to an embodiment of the present disclosure may perform upscaling on the content through the content image-quality improving module. For example, when the obtained editing information is the information with respect to enlargement of the play area of the content, the electronic device 1000 may perform upscaling on the content through the content image-quality improving module to appropriately determine a pixel value of pixels according to the enlargement of the play area. According to an embodiment, as the degree of enlargement of the play area of the content included in the editing information increases, the electronic device 1000 may increase the degree of upscaling performed on the pixel value of the pixels through the content image-quality improving module. Thus, even though the play area of the content is enlarged, the electronic device 1000 may improve the image quality of the content through the upscaling, and then may redistribute the content in which the image quality is improved to the display device 1010.

Also, the electronic device 1000 according to an embodiment of the present disclosure may improve the image quality of the content based on at least one of Nearest Neighborhood, Bilinear, Bicubic, and Laczos that are interpolation algorithms, but the electronic device 1000 is not limited thereto. The electronic device 1000 may need to determine values of the pixels increased according to the enlargement of the play area, and the electronic device 1000 may improve the image quality of the content through various methods of determining the values of the increased pixels.

In operation S1740, the electronic device 1000 according to an embodiment of the present disclosure may determine whether the obtained editing information is information with respect to reduction of the play area of the content.

When the obtained editing information is not the information with respect to enlargement of the play area of the content, the electronic device 1000 according to an embodiment of the present disclosure may determine whether the obtained editing information is the information with respect to reduction of the play area of the content.

When the editing information according to an embodiment of the present disclosure is the information with respect to reduction of the play area of the content, the editing information may indicate information with respect to zooming-out of the play area of the content. As the content editing module performs the editing of reducing the play area of the content, the number of pixels required for vividly outputting the content may be relatively lacking. Thus, when the obtained editing information is the information with respect to reduction of the play area of the content, the electronic device 1000 may perform at least one of denoising, brightness adjusting, and texture adjusting on the content to improve the resolution of the content.

In operation S1750, the electronic device 1000 according to an embodiment of the present disclosure may perform at least one of denoising, brightness adjusting, and texture adjusting on content through the content image-quality improving module.

When the content editing module according to an embodiment of the present disclosure reduces the play area of the content, the number of pixels required for vividly outputting the content may be relatively lacking. Thus, the electronic device 1000 may perform at least one of denoising, brightness adjusting, and texture adjusting on the content through the content image-quality improving module to improve the image quality of the content. For example, as the play area of the content is reduced, a boundary between a plurality of objects in the content may become faint, and thus, the image quality of the content may have to be improved. Here, the electronic device 100 may improve the image quality such that the boundary between the objects may be adjusted to be vivid, by adaptively adjusting the brightness and the texture of the pixels around the boundary between the objects. According to an embodiment, as the degree of reduction of the play area of the content included in the editing information increases, the electronic device 1000 may increase the degree of improving the image quality through the content image-quality improving module. Thus, even though the play area of the content is reduced, the electronic device 1000 may improve the image quality of the content through at least one of denoising, brightness adjusting, and texture adjusting, and then may redistribute the content in which the image quality is improved to the display device 1010.

In operation S1760, the electronic device 1000 according to an embodiment of the present disclosure may improve the image quality of the content based on at least one of image quality information of the content and dimension information of the display device.

When the obtained editing information according to an embodiment of the present disclosure is not the information with respect to enlargement of the play area of the content and the information with respect to reduction of the play area of the content, the obtained editing information may include at least one of information with respect to selection of the play area of the content and information with respect to addition of an image or text to the content. When the obtained editing information is at least one of the information with respect to selection of the play area of the content and the information with respect to addition of the image or the text to the content, the image quality of the content may be improved based on at least one of the image quality information of the content and the dimension information of the display device. For example, when the image quality of the content is full HD and the resolution dimension information of the display device is UWXGA, the electronic device 1000 may determine that the image quality of the content being played on the display device is lower compared to that according to the resolution dimension of the display device. Thus, the electronic device 1000 may improve, through the AI model, the image quality of the original content so that the content may be vividly played according to the resolution dimension of the display device.

In operation S1770, the electronic device 1000 according to an embodiment of the present disclosure may obtain the edited content having improved image quality through the content image-quality improving module.

The electronic device 1000 according to an embodiment of the present disclosure may obtain the edited content having improved image quality through the content editing module and the image-quality improving module. The electronic device 1000 may redistribute the edited content having improved image quality to the display device 1010 through the communicator 1230, and thus, the display device 1010 may rapidly and conveniently provide, to the user of the display device, the edited content processed according to the display situation of the display device.

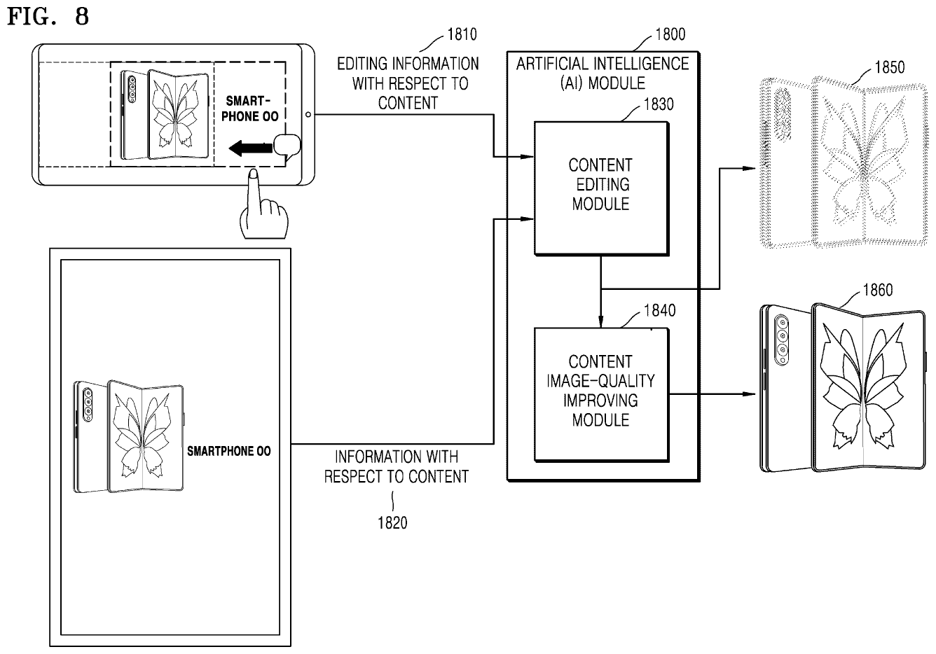

FIG. 8 is a diagram for describing a method of editing content, via an AI model, based on at least one of received editing information and information with respect to content, when the received editing information is information with respect to enlargement of a play area of the content, according to an embodiment of the present disclosure.

Referring to FIGS. 1, 2, and 8, an AI module 1800 according to an embodiment of the present disclosure may be stored in the memory 1210 and the AI module 1800 may include a content editing module 1830 and a content image-quality improving module 1840. Referring to FIG. 8, after an editing operation by the content editing module 1830 is performed, an image quality improving operation by the content image-quality improving module 1840 may be performed. However, it is not limited thereto. For example, after the image quality improving operation by the content image-quality improving module 1840 is performed, the editing operation by the content editing module 1830 may be performed.

The AI module 1800 according to an embodiment of the present disclosure may obtain editing information 1810 with respect to content and information 1820 with respect to the content. For example, the editing information 1810 with respect to the content obtained from the device 100 of the user may include information with respect to an editing operation of enlarging a play area of the content related to an advertisement of the smartphone [symbol] .” In detail, the editing information 1810 with respect to the content may be information with respect to an editing operation of enlarging a play area of the display device such that only an area of the content including the smartphone is displayed.

Also, the information 1820 with respect to the content according to an embodiment of the present disclosure may include at least one of image quality information of the content and dimension information of the display device. In detail, the size of the content displayed on the display device 1010 may be determined according to the dimension information of the display device and the size of the output image of the smartphone in the content may be not as large as the size according to the dimension of the display device. Thus, a viewer watching the content may not accurately recognize the image information or the text information in the content.

The content editing module 1830 according to an embodiment of the present disclosure may edit the content based on at least one of the editing information 1810 with respect to the content and the information 1820 with respect to the content. For example, the content editing module 1830 may perform editing of enlarging a play area of the content, based on the editing information 1810 with respect to the content. Content 1850 edited by the content editing module 1830 may be the content edited as a form in which the area of the smart phone in the content is enlarged, but is not limited thereto.

The content image-quality improving module 1840 according to an embodiment of the present disclosure may generate, based on the edited content 1850, edited content 1860 in which the image quality is improved. For example, the electronic device may improve the image quality of the edited content, by performing upscaling on the content to be edited, through the content image-quality improving module 1840. Thus, the edited content 1860 in which the image quality is improved may be content in a video form having image quality which is improved compared with the edited content 1850.

Via the AI module according to an embodiment of the present disclosure, the electronic device 1000 may obtain the edited content 1860 having improved image quality. The electronic device 100 may redistribute the edited content 1860 having improved image quality to the display device and the display device may play the edited content 1860 having improved image quality. Thus, the user of the display device may effectively figure out the image information in the content being displayed.

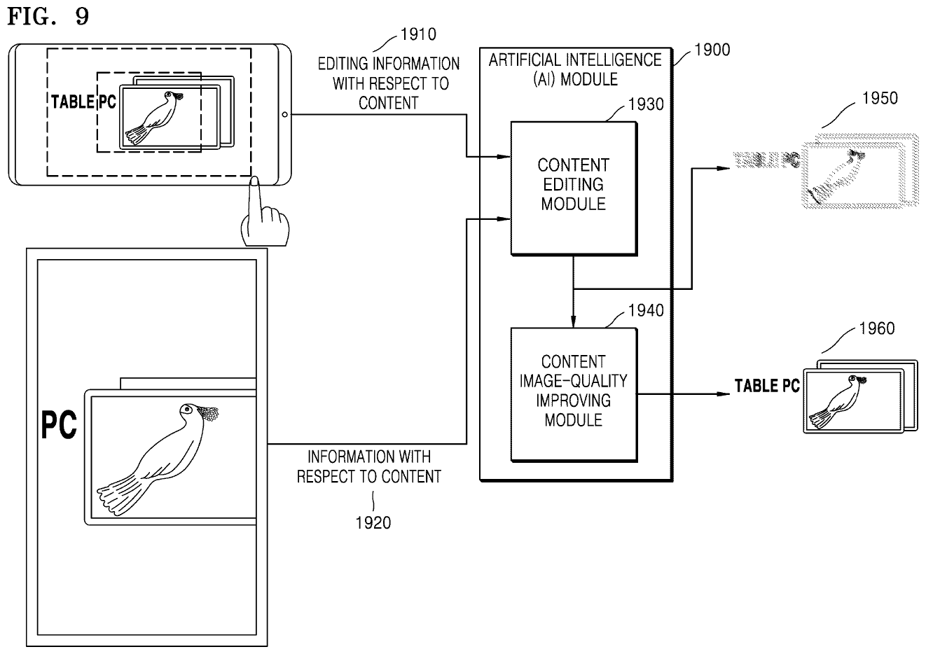

FIG. 9 is a diagram for describing a method of editing content, via an AI model, based on at least one of received editing information and information with respect to the content, when the received editing information is information with respect to reduction of a play area of the content, according to an embodiment of the present disclosure.

Referring to FIGS. 1, 2, and 9, an AI module 1900 according to an embodiment of the present disclosure may obtain editing information 1910 with respect to content and information 1920 with respect to the content. For example, the editing information 1910 with respect to the content may include information with respect to editing of reducing a play area of the content related to an advertisement of a “Tablet PC.” In detail, the editing information 1910 with respect to the content may be information with respect to the editing of reducing the play area played on the display device 1010 so that the entire area of the content is displayed. Also, the information 1920 with respect to the content may include at least one of image quality information of the content and dimension information of the display device. In detail, the content output on the display device 1010 may be determined based on the dimension information of the display device. For example, the content may have more horizontal pixels than vertical pixels and the display device 1010 may be in a shape in which a vertical length is greater than a horizontal length. Thus, based on a ratio between a horizontal area and a vertical area of the content and the dimension information of the display device, the play area of the content output on the display device 1010 may be limited. For example, referring to FIG. 9, the display device 1010 may display only some areas of the content and may not display other areas including “Tablet.”

The content editing module 1930 according to an embodiment of the present disclosure may edit the content based on at least one of the editing information 1910 with respect to the content and the information 1920 with respect to the content. For example, the content editing module 1930 may perform editing of reducing a play area of the content, based on the editing information 1910 with respect to the content. Content 1950 edited by the content editing module 1930 may be the content edited to entirely include the text “Tablet PC.”

The content image-quality improving module 1940 according to an embodiment of the present disclosure may generate, based on the edited content 1950, edited content 1960 in which the image quality is improved. For example, the electronic device may perform, through the content image-quality improving module 1940, at least one of denoising, brightness adjusting, and texture adjusting on the content subject to editing, to obtain the edited content 1960 in which the image quality is improved. Thus, the edited content 1960 in which the image quality is improved may be content in a video form having image quality which is improved compared with the edited content 1950. The electronic device 100 may redistribute the edited content 1960 having improved image quality to the display device 1010 and the display device 1010 may play the edited content 1960 having improved image quality. Thus, the user of the display device may effectively figure out text information in the content being displayed.

FIG. 10 is a diagram for describing a method of editing content based on at least one of received editing information and dimension information of a display device, according to an embodiment of the present disclosure.

Referring to FIGS. 1, 2, and 10, editing information 2010 with respect to content and information 2020 with respect to the content according to an embodiment of the present disclosure may indicate the information with respect to the content and the information with respect to the content in FIG. 8. Also, a content editing module 2030 according to an embodiment of the present disclosure may be the content editing module in FIG. 8.

A user according to an embodiment of the present disclosure may input editing information through a touch pad of the device 100. The electronic device 1000 may edit the content based on at least one of the editing information obtained from the device 100 of the user and the dimension information of the display device. Here, when the electronic device 1000 edits the content as a wrong ratio or a wrong size, the display device 1010 may not properly play the edited content. Thus, it may be necessary that the electronic device 1000 may edit the content as an accurate ratio and an accurate size.

A first area 2040 according to an embodiment of the present disclosure may be some areas of the content corresponding to the editing information transmitted from the device of the user. In detail, the user may input, through the touch pad, etc. of the device 100, the editing information including an editing feature of selecting, reducing, or enlarging a play area to be displayed on the display device 1010. For example, referring to FIG. 10, the first area 2040 may indicate an area in original content, the area corresponding to the editing information obtained from the device 100 of the user.

A second area 2050 according to an embodiment of the present disclosure may be an area determined based on horizontal dimension information of the display device and vertical dimension information of the display device included in the dimension information of the display device. In detail, the second area 2050 may have the same ratio as the ratio between the horizontal dimension and the vertical dimension of a display of the display device and may be an area determined based on an area 2010. For example, referring to FIG. 10, the display device may have a vertical length that is greater than a horizontal length, and thus, the second area 2050 may be an area configured to have the same horizontal dimension as the horizontal dimension of the first area 2040 while including the first area 2040.

A third area 2060 according to an embodiment of the present disclosure may be an area corresponding content edited by the content editing module 2030. The content editing module 2030 may edit the content based on the editing information 2010 with respect to the content and the information 2020 with respect to the content. For example, the electronic device 1000 may edit the content by generating a predetermined blank at an edge of the content for a gap between a bezel of the display device and the display of the display device when the display device 1010 displays the content. In detail, referring to FIG. 10, the third area 2060 corresponding to the edited content may have a ratio between horizontal/vertical areas that is the same as that of the second area 2050 and may have a predetermined blank between the first area 2040 and the third area 2060.

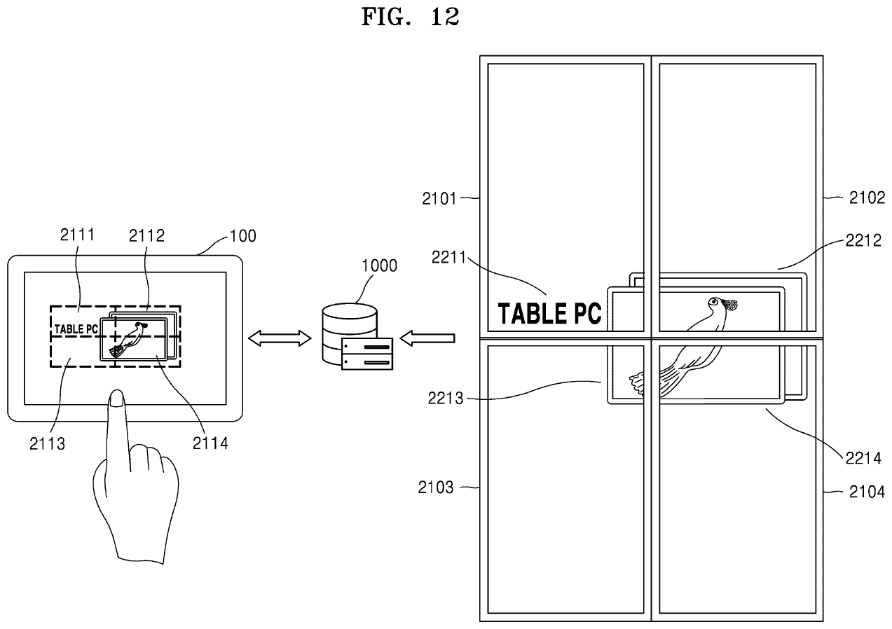

FIG. 11 is a diagram for describing a method of editing content based on at least one of information with respect to arrangement of a plurality of display devices, received editing information, and information with respect to the content, for the plurality of display devices to integrally play the content, according to an embodiment of the present disclosure. FIG. 12 is a diagram for describing a method of editing content based on at least one of information with respect to arrangement of a plurality of display devices, received editing information, and information with respect to the content, for the plurality of display devices to integrally play the content, according to an embodiment of the present disclosure.

Referring to FIGS. 11 and 12, in order that the plurality of display devices according to an embodiment of the present disclosure may integrally play content, the electronic device 1000 may edit the content based on at least one of information with respect to arrangement of the plurality of display devices, received editing information, and information with respect to the content.

The plurality of display devices of FIGS. 11 and 12 according to an embodiment of the present disclosure may include a first display device 2101, a second display device 2102, a third display device 2103, and a fourth display device 2104. Each of the plurality of display devices may be playing content 2100 as the same play area and the same resolution. The content 2100 may be video content including more horizontal pixels than vertical pixels and may not be appropriate to be displayed on a display device having a vertically elongated shape. For example, referring to FIG. 11, each of the plurality of display devices is playing “Tablet PC,” the text in the content, in a small font, and thus, a viewer watching the advertisement may not effectively watch the advertisement of the tablet PC.

The plurality of display devices according to an embodiment of the present disclosure may transmit, to the electronic device 1000, information with respect to arrangement of the first display device 2101, information with respect to arrangement of the second display device 2102, information with respect to arrangement of the third display device 2103, and information with respect to arrangement of the fourth display device 2104. For example, the information with respect to arrangement of the first display device 2101 may be information including a point located at an upper end of the third display device 2103 and a left side of the second display device 2102. Also, for example, the information with respect to arrangement of the first display device 2101 may include information that the position of the first display device 2101 is in a first quadrant or in a direction of 10 o′clock from among the plurality of display devices but is not limited thereto.

The device 100 of the user according to an embodiment of the present disclosure may transmit, to the electronic device 1000, the editing information with respect to the content. The user may transmit, to the electronic device 1000, the editing information with respect to the content including an editing feature of the content, through a touch pad, etc. In detail, the editing with respect to the content may include at least one of first editing information 2111 corresponding to the first display device, second editing information 2112 corresponding to the second display device, third editing information 2113 corresponding to the third display device, and fourth editing information 2114 corresponding to the fourth display device.

The electronic device 1000 according to an embodiment of the present disclosure may determine the first editing information 2111 corresponding to the first display device, the second editing information 2112 corresponding to the second display device, the third editing information 2113 corresponding to the third display device, and the fourth editing information 2114 corresponding to the fourth display device, based on segmented areas in a captured content image and the information with respect to arrangement of the plurality of display devices. Here, the segmented areas in the captured content image may correspond to the first editing information 2111, the second editing information 2112, the third editing information 2113, and the fourth editing information 2114, respectively.

In detail, referring to FIG. 11, the first editing information 2111 corresponding to the first display device 2101 may indicate editing information for zooming-in a play area of the content played on the first display device 2101 in some areas corresponding to a second quadrant of the captured content image. Also, for example, the second editing information 2112 corresponding to the second display device 2102 may indicate editing information for zooming-in a play area of the content played on the second display device 2102 in some areas corresponding to a first quadrant of the captured content image. Also, for example, the third editing information 2113 corresponding to the third display device 2103 may indicate editing information for zooming-in a play area of the content played on the third display device 2103 in some areas corresponding to a third quadrant of the captured content image. Also, for example, the fourth editing information 2114 corresponding to the fourth display device 2104 may indicate editing information for zooming-in a play area of the content played on the fourth display device 2104 in some areas corresponding to a fourth quadrant of the captured content image.

The electronic device 1000 according to an embodiment of the present disclosure may perform editing on the content to be redistributed to each of the plurality of display devices, based on the first editing information 2111 corresponding to the first display device, the second editing information 2112 corresponding to the second display device, the third editing information 2113 corresponding to the third display device, and the fourth editing information 2114 corresponding to the fourth display device.

Referring to FIG. 12, each of the plurality of display devices according to an embodiment of the present disclosure may directly play the edited content redistributed from the electronic device 1000. The first display device 2101 according to an embodiment of the present disclosure may output first content 2211 edited based on the first editing information 2111 corresponding to the first display device 2101. The edited first content 2211 may be some areas corresponding to a second quadrant of the original content. The second display device 2102 according to an embodiment of the present disclosure may output second content 2212 edited based on the second editing information 2112 corresponding to the second display device 2102. The edited second content 2212 may be some areas corresponding to a first quadrant of the original content. The third display device 2103 according to an embodiment of the present disclosure may output third content 2213 edited based on the third editing information 2113 corresponding to the third display device 2103. The edited third content 2213 may be some areas corresponding to a third quadrant of the original content. The fourth display device 2104 according to an embodiment of the present disclosure may output fourth content 2214 edited based on the fourth editing information 2114 corresponding to the fourth display device 2104. The edited fourth content 2214 may be some areas corresponding to a fourth quadrant of the original content.

The first display device 2101, the second display device 2102, the third display device 2103, and the fourth display device 2104 according to an embodiment of the present disclosure may play the edited first content 2211, the edited second content 2212, the edited third content 2213, and the edited fourth content 2214, respectively, to integrally play the content. Thus, each of the plurality of display devices may play the text information in the content in a large font and the plurality of display devices may integrally play a single piece of content, and thus, a customer viewing the advertisement may effectively view content of the advertisement of the tablet PC.

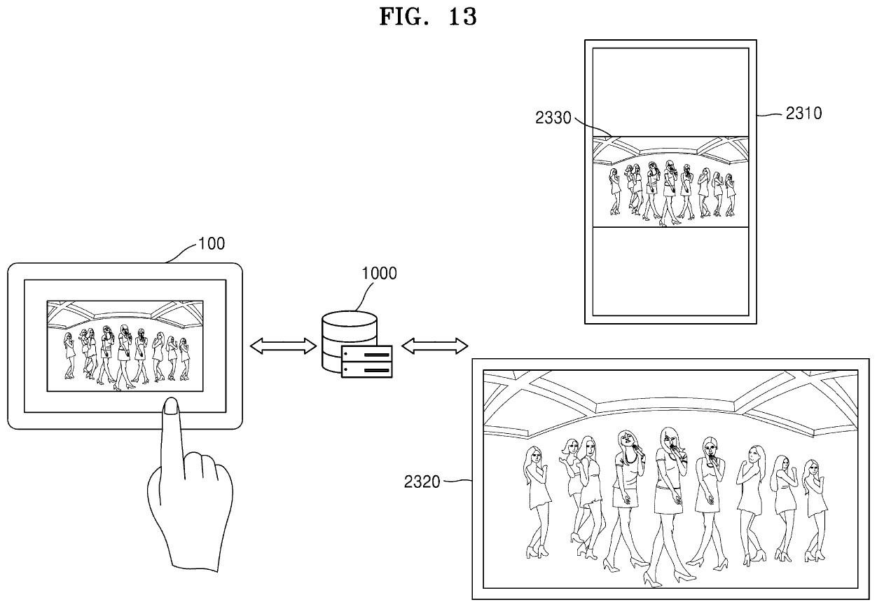

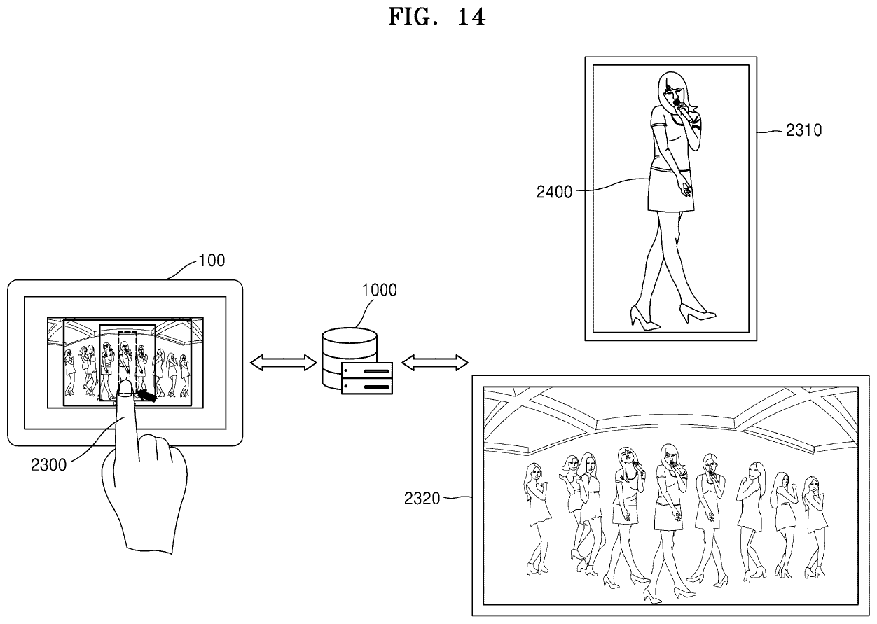

FIG. 13 is a diagram for describing a method of editing content based on at least one of information with respect to arrangement of a plurality of display devices, received editing information, and information with respect to the content, for the plurality of display devices to integrally play the content, according to an embodiment of the present disclosure. FIG. 14 is a diagram for describing a method of editing content based on at least one of information with respect to arrangement of a plurality of display devices, received editing information, and information with respect to the content, for the plurality of display devices to integrally play the content, according to an embodiment of the present disclosure.

The plurality of display devices of FIGS. 13 and 14 according to an embodiment of the present disclosure may include a first display device 2310 and a second display device 2320. The first display device 2310 may be a vertically elongated type-display device and the second display device 2320 may be a horizontally elongated type-display device. Content played on the plurality of display devices may be video content related to a performance, the video content including more horizontal pixels than vertical pixels. Thus, the second display device 2320, which is a horizontally elongated type-device, may play the content according to an appropriate ratio. On the contrary, the first display device 2310 may be a vertically elongated type-device and may play content 2330 before editing as a relatively decreased size. Thus, audience watching the performance may have difficulty effectively watching the content output by the first display device 2310.

The electronic device 1000 according to an embodiment of the present disclosure may obtain editing information from the device 100 of the user. In detail, the editing information may be information including an editing feature 2300 of enlarging a play area of the content as some areas. For example, referring to FIG. 13, the editing information may be information including the editing feature 2300 of zooming-in the play area as some areas including a singer in the video content with respect to the performance.

The electronic device 1000 according to an embodiment of the present disclosure may edit the content based on the editing information. In detail, the electronic device 1000 may perform, based on the editing information, the editing of zooming-in the play area to be played on the display device as some areas including the singer in the video content with respect to the performance.

According to an embodiment, the electronic device 1000 may provide original content to some display devices of the plurality of display devices and provide edited content 2400 to the other display devices. The electronic device 1000 may provide the edited content 2400 to the first display device 2310 and may provide the original content to the second display device 2320.

The display device 2310 according to an embodiment of the present disclosure may play the edited content 2400 received from the electronic device 1000. Thus, the first display device 2310 may integrally play the content related to the performance together with the second display device 2320.

According to an embodiment of the present disclosure, the electronic device may receive the captured content image and the information with respect to the content from the display device, transmit the captured content image to the device of the user, receive the editing information with respect to the content from the device, and edit the content based on at least one of the received editing information and the information with respect to the content, to transmit the edited content so that the display device may play the edited content. Accordingly, the electronic device may rapidly edit the play area of the content and redistribute the edited play area to the display device.

In the present specification, in a method according to an embodiment, a machine-readable storage medium may be provided in a form of a non-transitory storage medium. Here, the expression of “non-transitory storage medium” may only indicate that the medium is a tangible device, rather than a signal (for example, an electromagnetic wave), and does not distinguish a semi-permanent storage of data in the storage medium and a temporary storage of data in the storage medium. For example, the “non-transitory storage media” may include a buffer temporarily storing data.

According to an embodiment, the method according to various embodiments disclosed in the present specification may be provided as an inclusion of a computer program product. The computer program product may be, as a product, transacted between a seller and a purchaser. The computer program product may be distributed in the form of a machine-readable storage medium (e.g., a compact disc (CD)-ROM) or may be distributed online (e.g., downloaded or uploaded) through an application store or directly between two user devices (e.g., smartphones). In the case of online distribution, at least part of a computer program product (e.g., a downloadable application) may be at least temporarily stored in a machine-readable storage medium, such as a server of a manufacturer, a server of an application store, or a memory of a relay server, or may be temporarily generated.

The descriptions of the present disclosure above are examples, and it would be understood by one of ordinary skill in the art that the present disclosure may be easily modified as other specific forms without changing the technical concept or essential features of the present disclosure. Hence, it will be understood that the embodiments described above are examples in all aspects and are not limiting of the scope of the present disclosure. For example, each of components described as a single unit may be executed in a distributed fashion, and likewise, components described as being distributed may be executed in a combined fashion.

The scope of the present disclosure is indicated by the claims rather than by the detailed description of the present disclosure, and it should be understood that the claims and all modifications or modified forms drawn from the concept of the claims are included in the scope of the present disclosure.

What is claimed is:

1. An electronic device comprising:
a communicator;
a memory storing one or more instructions; and
at least one processor configured to execute the one or more instructions to:
control receiving, from a display device through the communicator, a captured content image of content being played on the display device and information with respect to the content;
control the communicator to transmit the captured content image to a device of a user and to receive editing information with respect to the content from the device;
edit the content stored in the memory, based on at least one of the received editing information and the information with respect to the content; and
control the communicator to transmit the edited content to the display device so that the edited content is played on the display device.

2. The electronic device of claim 1, wherein the at least one processor is further configured to edit the content based on at least one of the received editing information and the information with respect to the content, via an artificial intelligence (AI) model for editing the content.

3. The electronic device of claim 2, wherein
the AI model is configured to improve image quality of the content, and
the editing information includes at least one of information with respect to selection of a play area of the content, information with respect to enlargement of the play area of the content, information with respect to reduction of the play area of the content, and information with respect to addition of an image or addition of text to the content.

4. The electronic device of claim 3, wherein, when the received editing information is the information with respect to the enlargement of the play area of the content,
the at least one processor is further configured to improve the image quality of the content by performing upscaling on the content, via the AI model.

5. The electronic device of claim 3, wherein, when the received editing information is the information with respect to the reduction of the play area of the content, the at least one processor is further configured to improve the image quality of the content by performing at least one of denoising, brightness adjusting, and texture adjusting on the content, via the AI model.

6. The electronic device of claim 1, wherein the information with respect to the content includes at least one of information with respect to image quality of the content and dimension information of the display device playing the content.

7. The electronic device of claim 6, wherein
the dimension information of the display device includes at least one of horizontal dimension information of the display device and vertical dimension information of the display device, and
the at least one processor is configured to edit the content, based on at least one of the received editing information and the dimension information of the display device.

8. The electronic device of claim 1, wherein the at least one processor is further configured to control the communicator to transmit, to the device, at least one of a signal with respect to whether or not to edit the content and a signal with respect to an editing direction of the content and the captured content image.

9. The electronic device of claim 1, wherein the at least one processor is further configured to edit the content based on at least one of information with respect to arrangement of a plurality of display devices, the received editing information, and the information with respect to the content, so that the plurality of display devices integrally play the content.

10. The electronic device of claim 1, wherein the at least one processor is further configured to control the communicator to receive, from the display device, the information with respect to the content, according to an editing request signal of the user with respect to the content, transmitted from the device.

11. A method comprising:
receiving, from a display device, a captured content image of content being played on the display device and information with respect to the content;
transmitting the captured content image to a device of a user and receiving editing information with respect to the content from the device;
editing the content, based on at least one of the received editing information and the information with respect to the content; and
transmitting the edited content to the display device so that the edited content is played on the display device.

12. The method of claim 11, wherein the editing of the content comprises editing the content, based on at least one of the received editing information and the information with respect to the content, via an artificial intelligence (AI) model for editing the content.

13. The method of claim 12, wherein
the AI model is configured to improve image quality of the content, and
the editing information includes at least one of information with respect to selection of a play area of the content, information with respect to enlargement of the play area of the content, information with respect to reduction of the play area of the content, and information with respect to addition of an image or addition of text to the content.

14. The method of claim 13, wherein, when the received editing information is the information with respect to the enlargement of the play area of the content, the editing of the content comprises improving the image quality of the content by performing upscaling on the content, via the AI model.

15. The method of claim 13, wherein, when the received editing information is the information with respect to the reduction of the play area of the content, the editing of the content comprises performing at least one of denoising, brightness adjusting and texture adjusting on the content, via the AI model.

16. The method of claim 11, wherein the information with respect to the content comprising at least one of information with respect to image quality of the content and dimension information of the display device playing the content.

17. The method of claim 16, wherein the dimension information of the display device comprising at least one of horizontal dimension information of the display device and vertical dimension information of the display device, the editing of the content comprises editing the content, based on at least one of the received editing information and the dimension information of the display device.

18. The method of claim 11, wherein the receiving the information with respect to the content comprises transmitting at least one of a signal with respect to whether or not to edit the content and a signal with respect to an editing direction of the content and the captured content image to the device.

19. The method of claim 11, wherein the editing of the content comprises editing the content, based on at least one of information with respect to arrangement of a plurality of display devices, the received editing information and the information with respect to the content, so that the plurality of display devices integrally play the content.

20. A non-transitory computer-readable recording medium having recorded thereon a program for executing the method of claim 11 on a computer.
